(19) United States
(12) Patent Application Publication
(10) Pub. No.: US 2006/0283543 A1
(43) Pub. Date: Dec. 21, 2006

(54) Pseudo-transmission method of forming and joining articles

(76) Inventors: Masanori Kubota, Hockessin, DE (US); Ayako Kubota, Hockessin, DE (US); Munetaka Kubota, Hockessin, DE (US); Alexander Takuma Kubota, Hockessin, DE (US)

Correspondence Address: RATNERPRESTIA, P.O. BOX 1596, WILMINGTON, DE, 19899, US

(21) Appl. No.: 11/214,306

(22) Filed: Aug. 29, 2005

Related U.S. Application Data
(60) Provisional application No. 60/691,845, filed on Jun. 20, 2005.

(51) Int. Cl. B32B 37/00; B32B 37/06

(52) U.S. Cl. 156/272.2; 156/275.7; 264/492

(57) ABSTRACT

A process for heating a polymeric material throughout its thickness using infrared electromagnetic radiation, whereby there is dispersed in the polymeric material throughout its thickness an infrared radiation absorbing agent in an amount such that at least a portion of the infrared radiation incident on the material from one side exits from the opposite side. The absorbed radiation may selectably vary from 1% to 99%; the particular percentage is calculated to rapidly heat the material to a temperature that depends on a particular application, and may be sufficient to soften the material so it can be pressure formed into a desired shape or, alternatively, high enough to melt this material when placed between two surfaces and used to the two surfaces together.

### CROSS REFERENCE TO RELATED APPLICATIONS

This application claims the benefit of priority to U.S. Provisional application Ser. No. 60/691,845, filed Jun. 20, 2005, the contents of which are fully incorporated herein by reference.

### FIELD OF THE INVENTION

The present invention relates, in general, to joining an article using electromagnetic radiation. More specifically, the present invention relates to heating, and joining a polymeric article using electromagnetic radiation and a controlled amount of a radiation absorber agent.

### BACKGROUND OF THE INVENTION

Heating polymeric materials for secondary processing in polymeric parts fabrication is an important and critical process in manufacturing and assembly of a number of manufactured articles. Heating polymeric parts is commonly done in the industry by using a hot air convection, hot plate conduction or infrared radiation heat source to heat the part by heat conduction through the surface. The industry is moving toward using thermoplastic resins to build composite parts that can be reformed, reworked or joined to use the parts in further manufacturing processes.

The industry commonly uses heat convection, hot plate and/or infrared radiation in processes to join or weld polymer parts by heat conduction during assembly. One method of joining polymeric parts is by using hot-melt and heat set adhesives, shown as prior art in FIG. 3. In this method, a hot air source or hot plate heat source 301 directs heat 302 at the polymeric parts 303 and 304 to be joined. An adhesive layer 305 is placed between the polymeric parts to be joined. The source heats the polymeric parts and adhesive layer by conduction heating. The hot-melt adhesive has a melt temperature that is lower than the polymer being joined and melts via conduction heating. The adhesive bonds the polymers after cooling.

The heating is done by conduction and, as a result, has the limitations of being slow to heat and cool and not precisely controlled. The autoclave process used to consolidate the composite parts is a complex and time consuming process. Composite parts made by this process are expensive and limit the broader use of composite parts in the industry.

The use of heat conduction by the described processes to form polymeric parts is a time and energy consuming process because most polymers have low heat conductivity. Conduction heating is a slow process because it requires heating a large mass of polymer in the general area where the polymer is being softened. The heated part mass will also take time to cool after the forming process is complete. The heating and cooling time requirements make conduction heating to form or reform parts a slow production process. It is difficult to achieve a uniform temperature distribution across the process area. Excessive heat may be applied to the part to achieve acceptable processing times. Excessive heat in non-work areas can cause damage to sensitive parts that may be present. Conduction heating can generate high surface temperatures that may damage or deform the surface of the polymeric part.

U.S. Pat. No. 4,636,609 teaches a process of welding thermoplastics by the use of an infrared transparent part and infrared opaque part as illustrated in FIG. 4. The two parts 403 and 404 are held together under pressure and infrared radiation is projected through the infrared transparent part 403 onto the interface of the two parts. The projected infrared energy 402 is absorbed at the surface of the infrared opaque part 404. The infrared radiation energy is absorbed at the surface of the infrared opaque part and converted to heat that melts both parts at the interface where they melt and flow together to form a welded bond. The infrared radiation source 401 used in this patent is a laser. The radiation source used in the process can be other sources such as a focused infrared lamp as taught in U.S. Pat. No. 5,840,147. This welding process used to join a radiation transparent part to a radiation opaque part is referred to as through-transmission infrared welding (TTIR) and is commercially used in manufacturing products.

An issue with through-transmission welding at the interface of the parts to be joined is that the planar surface of the parts must be flat and smooth and the interface of the parts must tightly conform to each other. The radiation absorbing material can bridge and fill minor gaps at the interface when the part surfaces are melted by radiation. However, if gaps at the interface of the parts are too large, there will be uneven contact of the parts held together under pressure and a weak or defective bond will be formed at gap areas during welding. Using TTIR welding to join non-planar and contoured parts may require high precision molding or extrusion in forming the parts to achieve a tightly fitted interface and get consistent high strength welding. The TTIR welding process is limited to joining at a single interface and cannot weld more than two layers or parts together.

It is also desirable to have a joining process that is not dependent on the slow heat and cool cycles of heat conduction and adhesives. Such process should be applicable to joining by welding a broad range of polymers and composites and not limited by chemical compatibility.

The welding process should not produce a welded seam that has defects. Further, the welding process should minimally restrict the shape of the welded part manufactured. That is, the shape of the parts should not be limited to a planar or a smooth and flat interface or to a restricted seam design for uniform distribution of the welding radiation. The welding process should create a uniform and strong weld without blocking of the radiation at the welded interface, and should be applicable to weld a broad choice of thermoplastic plies, sheets, molded parts in one, two or three-dimensional configurations. Finally, the welding process should not be limited to expensive IR absorbers and absorber materials and should have the capacity to join multiple polymeric layers or multiple parts in one welding step.

Similar techniques and problems are encountered when forming polymeric parts. Forming or reforming a polymeric part is done using a hot plate to apply heat to the surface of the part. Typically, a hot metal surface is applied with pressure to the surface of the part and an area of the polymeric part is heated by conduction. The heated area becomes soft and pliable and the polymeric part can be formed into the shape of the hot metal form by applying pressure to the softened area. FIG. 1 shows an example of prior art, using a hot plate and heat conduction to seal a polymeric tube.

A convection heat source such as a hot air or hot gas source is used to do polymer part forming. The convection source is directed at the polymer part to heat the area to be formed. The convection heat is absorbed at the surface of the part to heat and soften the part. The part area to be reformed is heated by heat conduction from the surface of the part. A metal tool is applied under pressure to reform the part in the heat softened area. Another heat source used to reform a polymeric part is infrared electromagnetic radiation. Electromagnetic radiation, projected from a radiation source such as an infrared lamp, is applied to heat the polymeric surface area. The radiation is absorbed at the surface of the part and converted to heat. The rest of the part area to be reformed is heated by heat conduction from the surface and softened. A metal tool is applied under pressure to reform the part in the heat softened area.

There are several disadvantages of using conduction heating for reforming. Heating through the polymeric piece to soften the polymer requires time. Polymers typically have low heat conductivity and so a large amount of heat is required to soften the polymer. Areas outside the immediate area to be formed are heated through conduction by the hot plate. All of the heat applied to soften the polymer is initially applied onto and through the surface of the polymer and this can lead to surface deformation or degrading. The time for the polymer to cool after reforming is also longer since a bulk mass of polymer is initially heated to achieve the required melt conditions.

A typical method of forming polymeric composite materials into parts is done using a prepreg material, tow placement process and autoclave consolidation. The prepreg material is formed using a polymer resin and a high tenacity fiber material in a composite matrix. The polymer can be a thermoset or thermoplastic resin. The high tenacity fibers broadly used in making composites include carbon, glass fiber, polyaramide fiber, high tenacity polyethylene fibers and others.

Currently, the most widely used reinforced polymer composites are made using thermoset resin prepreg. The prepreg reinforced polymer composite material is used in a tow placement process to position the composite material onto a tooling in the shape of the part to be manufactured. A composite part is constructed by winding layers of a prepreg composite material onto a tooling. After winding, the part is placed into an autoclave to apply heat and pressure to consolidate the part.

The heating process is done in ramped stages so that the prepreg layers are gradually heated by conduction heating. During the conduction heating process, the thermoset resin chemically reacts to bond the individual prepreg materials to form a continuous solid composite in the form of the final part. During consolidation, the prepreg material bonds together, eliminating any physical gaps within the prepreg material and expelling trapped air or gas. If the prepreg is made using a thermoplastic resin, the autoclave heating and pressure process heats the resin by conduction to the glass transition temperature where it consolidates by melt flow to eliminate physical spaces and trapped gas from the solid composite part.

It would, therefore, be desirable to be able to form and to manufacture reinforced polymer composite parts without using the expensive and time consuming autoclaving process.

### SUMMARY OF INVENTION

It is therefore an object of the present invention to provide a process that uses controlled absorption of electromagnetic radiation and more particularly infrared irradiation in forming and joining polymeric parts. The irradiation process is accomplished by using a radiation absorber dispersed within a polymer part. The radiation absorber imparts the ability to partially absorb radiation and partially transmit radiation that is projected onto and through the polymeric part. The radiation is partially absorbed by the pseudo-transmission discrete polymeric layer and during the absorption process simultaneously heats the entire polymeric layer. In one embodiment, a radiation source is used in the process that projects near-infrared radiation onto the partially transmitting infrared absorber polymeric part. The radiation source can be a monochromatic laser type source or a polychromatic source having a radiation emission wavelength range between 700 nm and 2,000 nm.

A near-IR absorber is used to sensitize the polymer to be partially transparent to radiation. The absorber is sensitive to absorbing radiation in the wavelength range between 700 nm and 2,000 nm. The near-IR absorber can be dispersed into the polymer or applied to the surfaces of the polymer that is being formed or joined in the process. The near-IR absorber is dispersed or coated at a concentration to partially absorb and partially transmit near-IR radiation. The process uses a pseudo-transmission infrared radiation (PTIR) method to achieve controlled forming or joining of polymeric parts.

In one exemplary embodiment of the present invention, there is provided a pseudo-transmission infrared radiation (PTIR) method for forming a polymer. A near-IR absorber is dispersed into the polymer or applied to the surface of the polymer such that the polymer partially transmits infrared radiation. The radiation source projects radiation deep into the polymeric part. The radiation is absorbed throughout the polymeric part, that is, throughout the thickness of the polymeric part. The absorber in the part absorbs the radiation throughout the irradiated part and converts the radiation to heat. The entire layer on the polymeric part is heated simultaneously in the area that is irradiated. The polymeric part heats and softens and can be formed by applying an ambient temperature tooling device that is under pressure onto the soften polymer part. This invention provides a method to rapidly and precisely heat, form or reform and rapidly cool polymeric parts.

Another exemplary embodiment of the present invention provides a pseudo-transmission infrared radiation (PTIR) method for joining or welding polymeric parts. A radiation system is used to join a first polymeric article and second polymeric article by incorporating the use of a partial radiation absorbing third polymeric article. The third article is placed between and at the interface of the first and second articles. The third article has the unique ability to partially absorb radiation projected upon it. The third article contains a dispersed radiation absorber. The radiation absorber is at a concentration to partially absorb radiation. The radiation is partially absorbed and partially transmitted throughout the entire structure of the third article. The article absorbs the radiation, heats and melts the entire article. The third article is held with pressure between the first and second article. The melted polymer of the third article is in contact with and transfers heat by conduction to the surface interface of the first and second articles. Polymer diffusion occurs at the interface, bonding the first, second and third articles after cooling.

In another exemplary embodiment of the present invention, a pseudo-transmission infrared radiation (PTIR) method is applied to forming and joining reinforced thermoplastic composite parts. The reinforced composite part contains a thermoplastic resin and a high tenacity fiber. The thermoplastic resin has a near-IR absorber dispersed within the resin layer. The resin layer is partially transparent to near-IR radiation. The PTIR composite part is held against a second PTIR composite part under pressure. A near-IR radiation system is focused upon the PTIR reinforced thermoplastic composite part. The radiation is focused into the multiple PTIR composite parts. The PTIR composite parts partially absorb the radiation, heat and soften. The PTIR composite parts are joined to form a consolidated composite part.

### BRIEF DESCRIPTION OF DRAWINGS

The invention is best understood from the following detailed description when read in connection with the accompanying drawings. It is emphasized that, according to common practice, the various features of the drawings are not to scale. On the contrary, the dimensions of the various features are arbitrarily expanded or reduced for clarity. Included in the drawings are the following figures:

The view dimension for each figure from FIG. 1 to FIG. 9 is of a cross section view at the interface of the pseudo-transmission absorber interface and the polymeric parts being reformed or joined.

FIG. 1a, 1b Schematically illustrate the use of a hot plate for heat forming an article as practiced by the prior art.

FIG. 2a, 2b Schematically illustrate Pseudo-transmission welding for heat forming according to one embodiment of the present invention.

FIG. 3 Schematically illustrates the Prior art use of hot melt adhesive for joining polymers

FIG. 4 Schematically illustrates the Prior art use of through-transmission welding for joining polymers

FIG. 5 Schematically illustrates Pseudo-transmission welding of polymers using a single layer between the parts to be joined

FIG. 6 Schematically illustrates Pseudo-transmission welding of polymers using multiple layers

FIG. 7a, 7b Schematically illustrate Pseudo-transmission welding of two uneven surfaces

FIG. 8 Schematically illustrates Pseudo-transmission welding a curved surface

FIG. 9 Schematically illustrates Pseudo-transmission forming of reinforced thermoplastic composite material

### DETAILED DESCRIPTION OF THE INVENTION

Various apparatuses and methods of irradiating a surface or part using a radiant energy source are disclosed in U.S. Pat. No. 6,369,845 and U.S. Pat. No. 6,816,182 which are both incorporated herein by reference for their teachings in the art of irradiation of a surface using a radiant energy source.

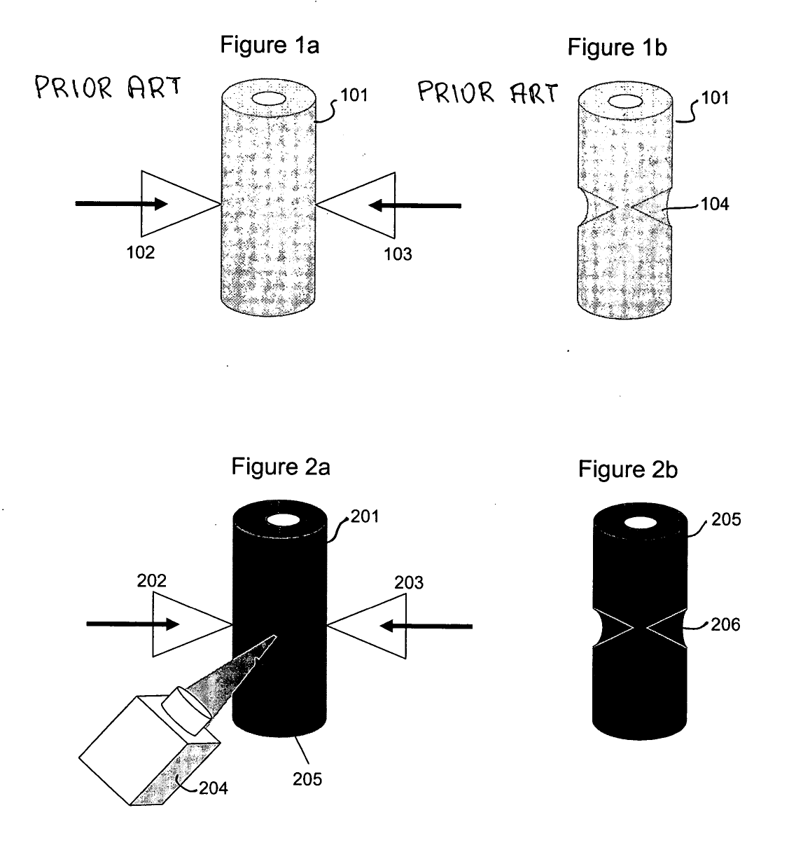

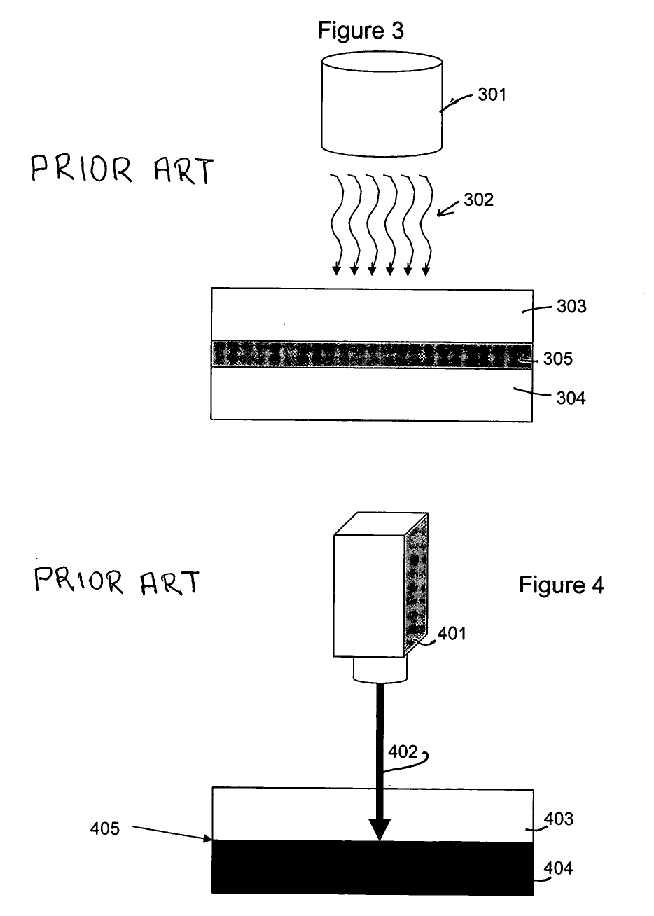

FIG. 1 illustrates the prior art of forming a polymeric part by heat conduction using a hot plate. Polymeric part 101 is a polymeric tube held in contact with hot plate wedges 102 and 103 as shown in FIG. 1a. The hot plates heat the polymeric walls until the walls soften and the plates are pressed into the tube wall surfaces and reform the polymeric material. The tube melts and is sealed off in area 104 as shown in FIG. 1b. Hot plates can be used to heat and reform parts into many shapes. A broad array of polymeric types, including thermoplastic parts that can be heated to or near their melting or glass transition point and formed or reformed using heated tooling.

FIGS. 2a and 2b illustrate an exemplary embodiment of the invention, using the pseudo-transmission technique to form a polymer tube. The polymer tube 201 is irradiated by a near IR radiation source 204 to soften the polymer. Cold plate wedge toolings 202 and 203 are then applied under pressure to form the polymeric material and seal off the tube in the area 206. In this example, the polymer tube 201 contains a quantity of a radiation absorber dispersed within the polymer. The concentration of absorber is set at a value to partially absorb some of the near-IR radiation and partially transmit some of the radiation. The transmitted radiation passes through the entire thickness of the wall of the tube.

The near-IR radiation source used can be a laser or polychromatic light source. The deep focal penetration radiation source described in U.S. Pat. No. 6,816,182 is ideal for use as a radiation source for the PTIR application. The emission wavelength range of the near-IR source is between 700 nm and 2,000 nm.

The optimum concentration of the absorber dispersed within the polymer is dependent on the thickness of the polymer layer, the absorptivity of the polymer and the absorptivity of the near-IR absorber. The objective is to project IR radiation throughout the polymer layer and have the radiation absorbed throughout the polymer layer to rapidly heat the polymer layer so that it will reform when tooling under pressure is applied. The pseudo-transmission process will work in the range of 1% to 99% transmission for the pseudo-transmission layer. The transmission value of 25% is the optimum transmission for near-IR radiation. (Conversely, the optimum absorption value is 75%.) The transmission value (or absorption) is for the combined transmission (or absorption) of the polymer part thickness and of the radiation absorber dispersed within the polymer in the pseudo-transmission layer.

The percentage by weight of infrared absorber dispersed into the polymer must be at a concentration that absorbs sufficient radiation throughout the polymer to rapidly soften or melt the polymer. The concentration is set so that the polymer is somewhat transparent and radiation penetrates into and throughout the polymer layer. The percentage by weight (concentration) of absorber dispersed into the polymer will depend on the type of absorber and absorption efficiency (absorption coefficient) of the absorber. The known relationship for calculating the concentration of absorber dispersed into the polymer is:
Absorption (%)=log (1/T)=A1B1+A2B1C2
A=absorption coefficient, B=thickness of layer, C=concentration absorber,
1=polymer, 2=IR absorber

The polymer itself may contribute to the near-IR absorption in the 700 nm to 2,000 nm wavelength range. The % A is measured across the wavelength output range for the near-IR radiation source.

The pseudo-transmission layer partially absorbs near-IR radiation thereby resulting in heating the polymer layer throughout its full thickness.

This layer can be formed by several methods. A near-IR absorber can be uniformly dispersing throughout the polymer layer. Infrared absorbing materials that can be dispersed include carbon black, graphite, charcoal, talc, glass filler, metal oxides, ceramics, phthalocyanine pigment, and other infrared absorbing organic or inorganic pigments or dyes known in the art. Metal powders, such as stainless steel, brass, aluminum, copper and others can also be dispersed in the polymer as infrared absorbers. The IR absorber is dispersed into the polymer using dispersion techniques known to the industry.

Polymer materials containing the IR absorber that can be used in practicing this invention can be selected from thermoplastic polymers including polyolefin, polyamide, polyester, polyacrylate, polycarbonate, polystyrene, polyurethane and polyvinyl chloride. Other types of polymers that can be used for the PTIR layer include fluoropolymers and thermoelastomers including thermoplastic olefins and thermoplastic vulcanizates.

Thermoset Plastics such as polyimide and epoxy resin, phenolic resin, urea resin, melamine resin, unsaturated polyester resin, polyurethane are also useful. A preferred thermoset Polyimide is The SKYBOND® 700 made by Industrial Summit Technology Company, 500 Cheesequake Road, Parlin, N.J. 08859. 3M 2214 epoxy resin is another preferred material used for this invention.

There are several key advantages of using the PTIR process for forming or reforming polymers. The radiation passes into the absorption layer of the polymer and heats the entire layer simultaneously and the polymer heating process is very fast. The radiation can be precisely controlled during the heating process and only the area that needs to be softened for reforming is heated. Therefore, only a small mass of polymer is heated and the heating and cooling cycle times are rapid. The radiation is projected through the reform layer uniformly, reducing the possibility of degrading the surface of the reformed polymer.

In one example, a polymer tube was sealed using a conventional hot plate process. The same tube sealing application was done using the pseudo-transmission method. The production time required for the pseudo-transmission process for sealing the tube was twice as fast as the hot plate.

Another exemplary embodiment of the present invention provides a pseudo-transmission infrared radiation (PTIR) method for joining and welding polymers.

When using through-transmission welding to join the polymer parts the planar surface of the parts must be flat and smooth and the interface of the parts must tightly conform to each other. The radiation absorbing material can bridge and fill minor gaps at the interface when the part surfaces are melted by radiation. However, if gaps at the interface of the parts are too large, there will be uneven contact of the parts held together under pressure and a weak or defective bond will be formed at gap areas during welding. Using TTIR welding to join non-planar and contoured parts may require high precision molding or extrusion in forming the parts to achieve a tightly fitted interface and get consistent high strength welding.

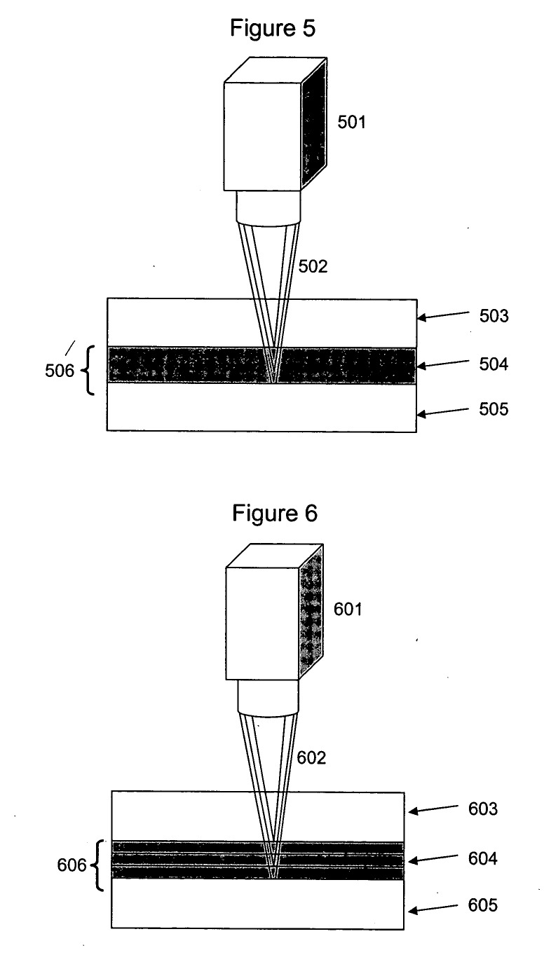

The use of the pseudo-transmission welding PTIR process for joining polymer parts as described in accordance with this invention is shown in FIG. 5. Polymer parts 503 and 505 are transparent to near-IR radiation. Polymer part 504 is at the interface 506 of 503 and 505. Part 504 is a PTIR layer that is partially transparent to near-IR radiation. The radiation source 501 projects near-IR radiation 502 onto the interface and part 504. The radiation is partially absorbed throughout the layer 504 and rapidly heats and melts the PTIR layer. The sandwich of the polymer parts with PTIR between them is held under pressure during irradiation. The melted polymer layer 504 conducts heat to the interface and melts with polymer diffusion into layers 503 and 505. The polymers cool and are welded together.

The near-IR radiation source 501 can be a laser or polychromatic light source. The emission near-IR radiation from the source is at a wavelength between 700 nm and 2,000 nm. The deep focal penetration radiation source described in U.S. Pat. No. 6,816,182 is ideal for use as a radiation source for the PTIR application.

The optimum concentration of the absorber dispersed within the polymer layer 504 is dependent on the thickness of the polymer wall, the absorptivity of the polymer and the absorptivity of the near-IR absorber. The objective is to project IR radiation throughout the PTIR polymer layer and have the radiation absorbed throughout the polymer layer to rapidly heat the polymer layer so that it will melt. The melted PTIR layer will conduct heat to and melt the interface at the surface of polymer layer 503 and 505 while pressure is applied. The pseudo-transmission process will work in the range of 1% to 99% transmission for the pseudo-transmission layer. The optimum absorption value for near-IR radiation is 75% for the combined absorption of the polymer part thickness and absorber added to the polymer in the pseudo-transmission layer.

The percentage by weight of infrared absorber dispersed into the polymer 504 must be at a concentration that absorbs sufficient radiation to melt the polymer and bond to the top 503 and bottom 505 polymer parts. The concentration is set so that 504 is somewhat transparent to infrared radiation. Radiation must be absorbed in 504 to melt and weld the polymer to the part 503 at the top surface of the interface. At the same time, radiation must penetrate into and through 504 to a sufficient depth to melt and weld the bottom of 504 to the bottom polymer interface of part 505. The polymer layer 504 must also melt sufficiently to flow into the gaps at the surface interface. The percentage by weight (concentration) of absorber dispersed into the polymer will depend on the type of absorber and absorption efficiency (absorption coefficient) of the absorber.

The percentage by weight of infrared absorber dispersed into the polymer must be at a concentration that absorbs sufficient radiation throughout the polymer to soften the polymer. The concentration is set so that the polymer is somewhat transparent and radiation penetrates into and through the polymer. The percentage by weight (concentration) of absorber dispersed into the polymer will depend on the type of absorber and absorption efficiency (absorption coefficient) of the absorber. The known relationship for calculating the absorption based on the concentration of absorber dispersed into the polymer and the PTIR layer thickness is:
Absorption (%)=log (1/T)=A1B1+A2B1C2
A=absorption coefficient, B=thickness of layer, C=concentration absorber,
1=polymer, 2=IR absorber
Again the polymer may have IR absorption characteristics. The % A is measured across the wavelength output range for the near-IR radiation source.

The PTIR layer with the optimum partial absorption characteristics is made by uniformly dispersing an infrared absorbing material throughout the PTIR polymer layer. Infrared absorbing materials that can be dispersed include carbon black, graphite, charcoal, talc, glass filler, ceramics, metal oxides, phthalocyanine pigment, and other infrared absorbing organic or inorganic pigments or dyes known in the art. Metal powders, such as stainless steel, brass, aluminum, copper and others can also be dispersed in the polymer matrix as infrared absorbers. The IR absorber is dispersed into the polymer using dispersion techniques known to the industry.

Polymer materials used as a matrix in preparing the PTIR layer can be selected from the family of thermoplastics including polyolefin, polyamide, polyester, polyacrylate, polycarbonate, polystyrene, polyurethane and polyvinyl chloride. Engineering thermoplastics such as polyimide, polyamideimide, polyketone and polyetheretherketone can be used. Other types of polymers that can be used include fluoropolymers and thermoelastomers including thermoelastomer olefins and thermoelastomer vulcanizates.

The PTIR polymer can be formed as a discrete partial absorber layer by cast coating or extruding the polymer with absorber into a film. The absorber-polymer can be formed into a PTIR layer by using two-color molding or co-extrusion. The polymer can be extruded into other forms such as tubing, parts, etc.

FIG. 6 illustrates an alternative embodiment of the present invention, showing the use of multiple PTIR layers used in joining polymer parts to be welded. Polymer parts 603 and 605 are transparent to infrared radiation. The multiple PTIR layers, shown as 604 partially absorb near-IR radiation. The near-IR source 601 projects radiation 602 onto and through the interface 606 of multiple PTIR layers held under pressure and the layers are welded together to join the parts.

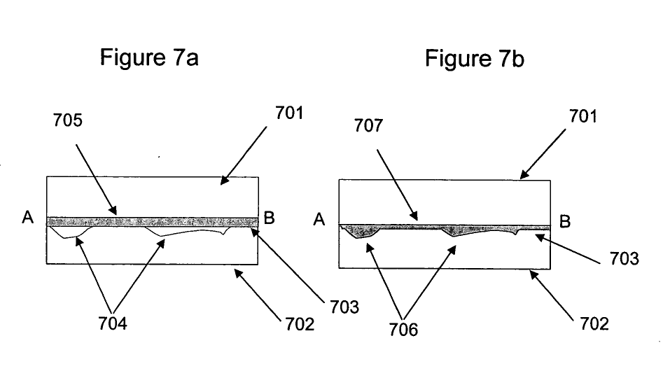

The maximum thickness of the polymer layer 703 used in this process depends on the size or thickness diameter of the non-conformities, gaps, and spaces at the interface of the parts being welded 704 as shown in FIGS. 7a and 7b. The maximum diameter thickness of layer 703 depends on the dimensional configuration and overall size of the parts being joined. Parts that are molded into two-dimensional forms can have gaps at the interface surface. A PTIR layer can be used in this example to assist in joining these parts. The dimension of the gap and PTIR layer thickness may be several millimeters wide. The thickness of the PTIR layer must be sufficient to fill the gap and provide intimate contact between the PTIR layer and parts while the parts are pressed together under pressure.

FIG. 7a shows the PTIR layer 703 between parts 701 and 702 that have non-conformities 704 at the interface. FIG. 7B shows the result after welding the PTIR layer. The layer 703 melts and fills the gaps 706 at the interface forming a strong bond to parts 701 and 702.

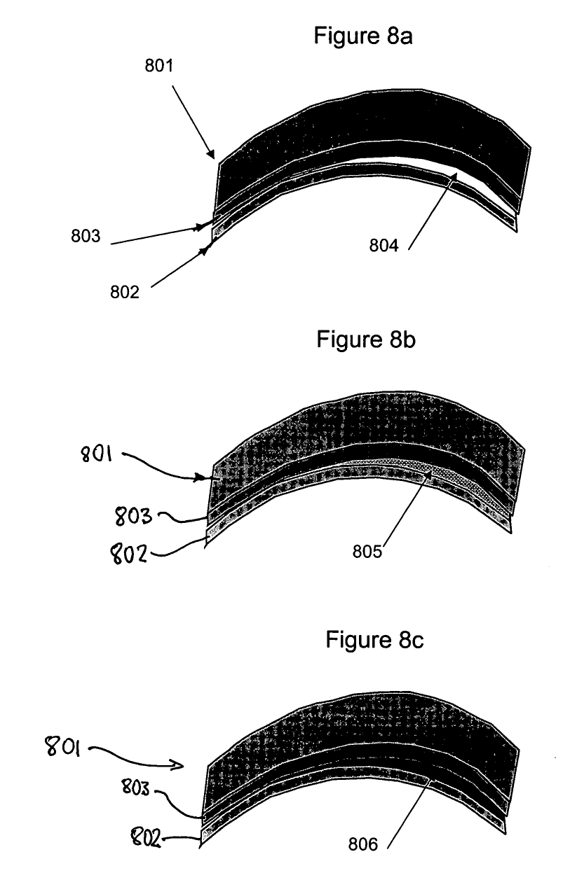

FIG. 8 illustrates an alternative embodiment of the present invention, showing the use of a PTIR polymeric layer 806 used to weld three-dimensional curved parts. Parts that are molded into three-dimensional forms can have large gaps at the interface surface, especially in a curvature area.

FIG. 8a shows an example of molded article 801 that has a three dimensional curvature that can leave a large gap 804 between the parts 803 and 802. FIG. 8b shows a PTIR layer 805 can be placed between the near-IR transparent parts 801 and 802 in this example to assist in joining these parts. The dimension of the gap and PTIR layer thickness may be several millimeters to several centimeters wide. The diameter or thickness of the PTIR layer 805 must be sufficient to fill the gap and provide intimate contact between the PTIR layer and parts while the parts are pressed together under pressure. FIG. 8c shows the parts joined 806 after welding.

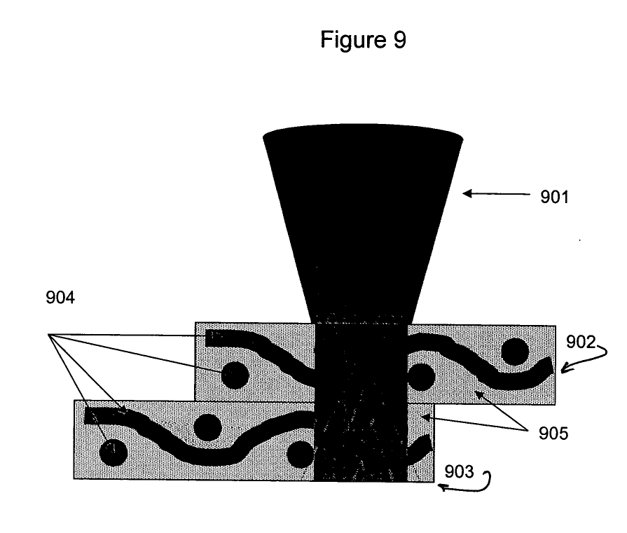

Another exemplary embodiment of the present invention provides a pseudo-transmission infrared radiation (PTIR) method for consolidation, forming and joining reinforced thermoplastic composite materials as shown in FIG. 9.

A near-IR source projects radiation 901 onto and through the reinforced thermoplastic composite layers 902 and 903. The reinforced thermoplastic composite layer composition includes a thermoplastic resin with a pseudo-transparent IR absorber dispersed within the resin 905 and a high tenacity reinforcing fiber 904 held within the composite structure. The radiation 901 is partially absorbed by the absorber in the resin and simultaneously heats the discrete layers of resin. The resin is heated to the glass transition point so that the resin layer 902 and 903 will melt and flow together at the interface to form a composite part. Multiple layers of reinforced thermoplastic composite can be laid down and built into a composite part.

The near-IR radiation source used can be a laser or polychromatic light source. The deep focal penetration radiation source described in U.S. Pat. No. 6,816,182 is ideal for use as a radiation source for the PTIR application. The emission wavelength range of the near-IR source is between 700 nm and 2,000 nm.

The resins used in preparing the PTIR composite layer 905 can be selected from the family of thermoplastics including engineering thermoplastics such as polyimide, polyamideimide, polyketone and polyetheretherketone can be used.

The PTIR composite layer with the optimum partial absorption characteristics is made by uniformly dispersing an infrared absorbing material throughout the PTIR composite polymer layer. Infrared absorbing materials that can be dispersed include carbon black, graphite, charcoal, talc, glass filler, ceramics, metal oxides, phthalocyanine pigment, and other infrared absorbing organic or inorganic pigments or dyes known in the art. Metal powders, such as stainless steel, brass, aluminum, copper and others can also be dispersed in the polymer as infrared absorbers. The IR absorber is dispersed into the polymer using dispersion techniques known to the industry.

The optimum concentration of the absorber dispersed within the resin is dependent on the thickness of the polymer wall, the absorptivity of the polymer and the absorptivity of the near-IR absorber. The objective is to project IR radiation throughout the polymer layer and have the radiation absorbed throughout the polymer layer to rapidly heat the polymer layer so that it will reform when tooling under pressure is applied. The pseudo-transmission process will work in the range of 1% to 99% transmission for the pseudo-transmission layer. A transmission value of 75% is the optimum transmission for near-IR radiation. The transmission value is for the combined transmission of the polymer part thickness and transmission of the radiation absorber dispersed within the polymer in the pseudo-transmission layer.

The percentage by weight of infrared absorber dispersed into the polymer must be at a concentration that absorbs sufficient radiation throughout the polymer to rapidly soften the polymer. The concentration is set so that the polymer is somewhat transparent and radiation penetrates into and throughout the polymer layer. The percentage by weight (concentration) of absorber dispersed into the polymer will depend on the type of absorber and absorption efficiency (absorption coefficient) of the absorber. The known relationship for calculating the concentration of absorber dispersed into the polymer is:
Absorption (%)=log (1/T)=A1B1+A2B1C2
A=absorption coefficient, B=thickness of layer, C=concentration absorber,
1=polymer, 2=IR absorber

As stated previously, the polymer may contribute to the near-IR absorption in the 700 nm to 2,000 nm wavelength range. The % A is measured across the wavelength output range for the near-IR radiation source.

The high tenacity fibers 904 that can be used in making the composite layer include carbon, glass fiber, polyaramide fiber, high tenacity polyethylene fibers, LCP and others.

The PTIR composite layer can be formed by coating the high tenacity fibers with the thermoplastic resin containing the PTIR absorber. The fiber geometry within the composite layer can be unidirectional in a prepreg configuration. The fibers can be in woven in a two-dimensional configuration and coated with the resin polymer containing the PTIR absorber. Coating techniques known to the industry can be used in preparation of the PTIR composite layer.

Although illustrated and described herein with reference to certain specific embodiments, the present invention is nevertheless not intended to be limited to the details shown. Rather, various modifications may be made in the details within the scope and range of equivalents of the claims and without departing from the spirit of the invention.

What is claimed:

1. A process for heating a polymeric material having a thickness between a front and a back surface, the process comprising:
selecting said polymeric material having dispersed therein throughout said thickness an infrared radiation absorbing agent in an amount such that at least a portion of infrared electromagnetic radiation incident on said first surface exits from said second surface; and
exposing said polymeric material to said infrared electromagnetic radiation through said first surface whereby a portion of said radiation is absorbed into said polymeric material thereby heating said polymeric material.

2. The process according to claim 1 wherein the absorbing layer absorbs at least 2% of the transmitted radiation.

3. The process according to claim 1 whereby said radiation absorbing layer comprises one or more of the following radiation absorbing agents: carbon black, graphite, charcoal, talc, glass filler, metal oxides, ceramics, phthalocyanine pigment, and metal powders.

4. The process according to claim 3 wherein the radiation absorbing agent is dispersed in a matrix comprising polyolefin, polyamide, polyester, polyacrylate, polycarbonate, polystyrene, polyurethane and polyvinyl chloride, polyimide, polyamideimide, polyketone, polyetheretherketone, fluoropolymers, polyimide and epoxy resin, phenolic resin, urea resin, melamine resin, unsaturated polyester resin and thermoelastomers including thermoelastomer olefins and thermoelastomer vulcanizates.

5. The process according to claim 1 wherein said polymeric material is exposed to sufficient infrared radiation to heat said polymeric material to a softened state and wherein after heating said polymeric material to said softened stated said softened material is pressure formed into a desirable shape.

6. A process for joining two surfaces comprising
placing between said two surfaces and in contact therewith an infrared radiation absorbing layer comprising a resin matrix and dispersed therein at least one infrared radiation absorbing agent in an amount such that at least a portion of said infrared radiation incident on said layer through a first surface thereof exits through a second surface of said layer opposite said first surface;
exposing said infrared absorbing layer to infrared radiation through said first surface to heat throughout its thickness said absorbing layer to a temperature at least sufficient to tackify said radiation absorbing layer thereby to join said two surfaces.

7. The process according to claim 6 further comprising applying pressure while exposing said infrared radiation to infrared radiation to maintain contact between said two surfaces and said infrared absorbing layer placed there between.

8. The process according to claim 6 wherein the absorbing layer absorbs at least 2% of the transmitted radiation.

9. The process according to claim 8 whereby said radiation absorbing layer comprises one or more of the following radiation absorbing agents: carbon black, graphite, charcoal, talc, glass filler, metal oxides, ceramics, phthalocyanine pigment, and metal powders.

10. The process according to claim 8 wherein the radiation absorbing agent is dispersed in a matrix comprising polyolefin, polyamide, polyester, polyacrylate, polycarbonate, polystyrene, polyurethane and polyvinyl chloride, polyimide, polyamideimide, polyketone, polyetheretherketone, fluoropolymers, polyimide and epoxy resin, phenolic resin, urea resin, melamine resin, unsaturated polyester resin and thermoelastomers including thermoelastomer olefins and thermoelastomer vulcanizates.
